(19) United States
(12) Patent Application Publication
(10) Pub. No.: US 2022/0101514 A1
(43) Pub. Date: Mar. 31, 2022

(54) METHOD FOR RECYCLING RECYCLABLE MATERIALS, ELECTRONIC EQUIPMENT, AND NON-TRANSITORY STORAGE MEDIUM

(71) Applicant: Shenzhen Fugui Precision Ind. Co., Ltd., Shenzhen (CN)

(72) Inventor: CHIA-HSUAN YANG, New Taipei (TW)

(21) Appl. No.: 17/328,220

(22) Filed: May 24, 2021

(30) Foreign Application Priority Data
Sep. 25, 2020 (CN) 202011027310.4

(51) Int. Cl. G06T 7/00; G06K 9/62; G06T 7/60; G06T 1/00; B07C 5/342

(52) U.S. Cl. CPC G06T 7/0004; G06K 9/6268; G06T 7/60; G06T 2207/30164; B07C 5/3422; G06T 2207/20084; G06T 1/0014

(57) ABSTRACT

A method for recycling containers such as cartons includes: an image of a flattened carton which may be recyclable is taken, the image of the carton be recognized and analyzed to determine whether the carton is intact or not. A distance-measuring device obtains the shape of any damaged area when the carton is not intact. A damage type of each damaged area is identified according to the shape of the damaged area. A damage rate of the carton is calculated, and according to an available repair plan, the carton is sorted and recycled when the total damage rate of the carton is less than a preset standard value. An electronic device and a storage medium are also disclosed.

### FIELD

The subject matter herein generally relates to recycling, in particular to a carton recycling method, a electronic equipment and a storage medium thereof.

### BACKGROUND

In the production process, some old containers and cartons are discarded after being used only one time, this is wasteful. These discarded materials are cheap to recycle and some containers and cartons may still be in good condition and reusable. The reuse of materials can effectively reduce production cost. However, determining whether a carton or other container is reusable takes a lot of time to do manually, and such manpower can easily make mistakes as to whether the carton or other container is actually reusable.

### BRIEF DESCRIPTION OF THE DRAWINGS

Implementations of the present technology will now be described, by way of embodiment, with reference to the attached figures, wherein:

FIG. 1 is an electronic device diagram of a materials recycling system in one embodiment.

FIG. 2 is a flowchart of one embodiment of a method for recycling materials.

FIG. 3 is a diagram showing shapes of known damage types in container materials.

FIG. 4 is a diagram showing quantized shapes representing each damage type in a damage identification model.

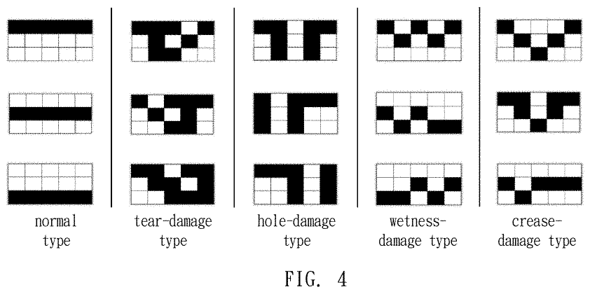

FIG. 5 is an expanded view of a container (a carton) in one embodiment.

FIG. 6a is a coordinate map of a standard carton placement position in one embodiment.

FIG. 6b is a coordinate map of a recycled carton placement position in one embodiment.

FIG. 6c is an angle diagram between the longest vector of the recycled carton and the longest vector of the standard carton in one embodiment.

FIG. 6d is a carton with adjusted position in an embodiment.

FIG. 7 is an application structure diagram of a container recycling system in one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. The term “comprising,” when utilized, is “including, but not necessarily limited to”; it specifically indicates open-ended inclusion or membership in the so-described combination, group, series, and the like. References to “an” or “one” embodiment in this disclosure are not necessarily to the same embodiment, and such references mean “at least one.”

A method for recycling a carton is applicable to an electronic device 1, a program of recycling the carton can be executed by the electronic device 1, for example, a personal computer, a server, etc. The server can be a single server, a server cluster, or a cloud server.

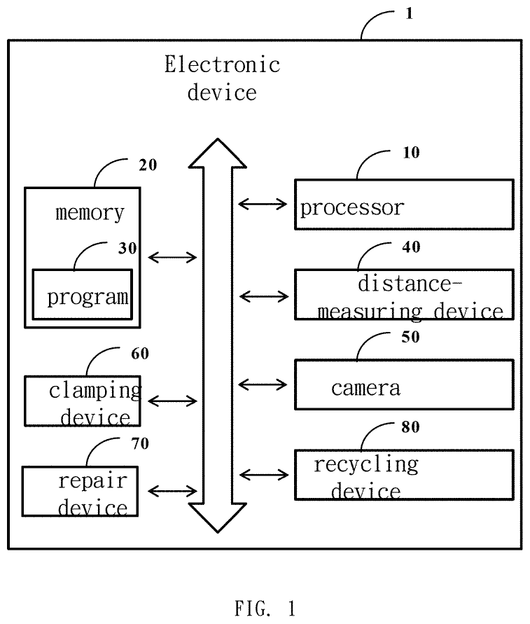

FIG. 1 shows an electronic device (electronic device 1) of a carton recycling system in one embodiment. The electronic device 1 includes the processor 10, the memory 20, the programs 30, the distance-measuring device 40, the camera 50, the clamping device 60, the repair device 70, and the recycling device 80. The programs 30 govern the recycling of the cartons. The processor 10 executes the programs 30 to implement the steps or the functions of each module of the embodiment in the carton recycling method.

In the embodiment, the programs 30 can be divided into one or more modules store in the memory 20 and be executed by the processor 10. For example, the programs 30 can be divided into the establish module 101, the camera module 102, the determined module 103, the adjust module 104, the scan module 105, the identify module 106, the calculate module 107, the repair module 108, and the recycling module 109. Those skilled in the art can understand that FIG. 1 is only the example of the electronic device 1, but does not constitute the limitation on the electronic device 1. Other electronic devices may include more or less component than those shown in the FIG. 1 or different combinations of certain components, or different components.

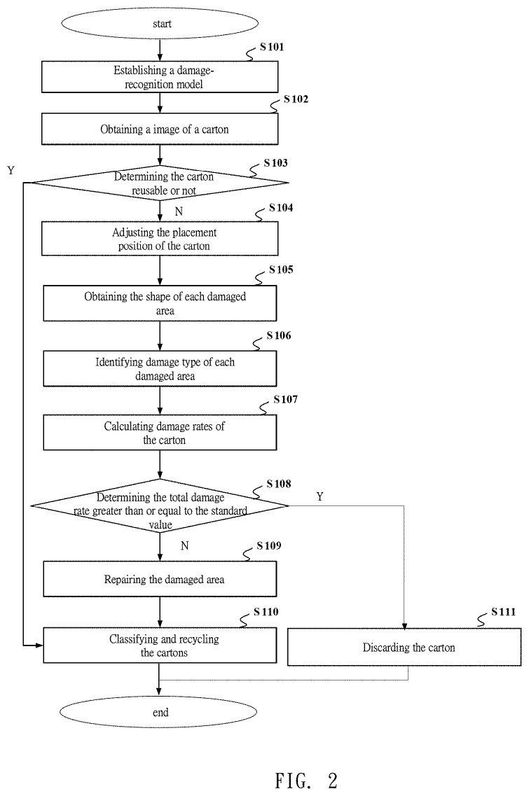

FIG. 2 is a flowchart of one embodiment of a method for recycling a carton. Order of the steps in the flowchart can be changed or some steps can be omitted according to different demands.

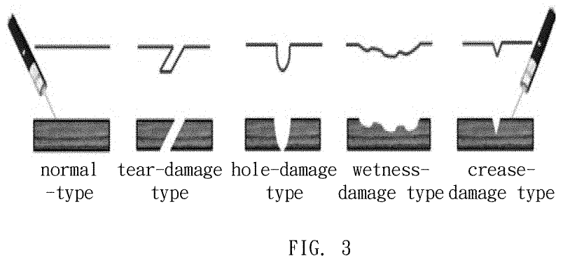

In step S101, a damage-recognition model is established based on a shape corresponding to a damaged area of a known damage type on damaged samples of cartons. Specifically, in step S101, a distance-measuring device 40 scans the damaged area to obtain the shape of the known damage type. The distance-measuring device 40 is a laser rangefinder in the embodiment. The known damage types include but are not limited to a normal (undamaged) type, a tear-damage type, a hole-damage typed, a crease-damage type, and a wetness-damage type. The distance-measuring device 40 scans the damaged area in a planned path by launching laser. The shape of the known damage type is obtained according to the distance between the distance-measuring device 40 and the outline of each shape indicating brokenness. FIG. 3 illustrates a relationship between the shape and the undamaged and the known damage types. The planned path is a path that moves along the edges of the damaged area.

In step S101, the shape of the known damage type is converted into an image (D-image). In the embodiment, the shape of the damaged area is converted into the D-image with the same scale resolution as M*N.

In step S101, a damage-recognition model is constructed. The damage-recognition model obtains features of D-image and classification of known damage type according to a CNN (Convolution Neural Network) model. In the embodiment, the D-image is used as an input of the CNN model. The features of the D-image are obtained according to a process of multiple convolutions and multiple down-sampling of the CNN model. The features of the damaged-trajectory image are classified through CNN model, and output is an image of non-damage (normal) container (S-image) with the resolution of X*Y to establish the damage-recognition model. X<M, Y<N, ratio of X to Y is the same as ratio of M to N. For example, X*Y is 5*3. In the embodiment, the S-image and standard model is stored in a database according to a rule of the damage classification.

In step S102, an image of a carton is obtained by the camera 50. In the embodiment, the carton is manually removed, staples and fasteners and the contents are taken out. The carton is flattened and exposed to the electronic device 1. Specifically, in step S102, the carton is flattened and exposed to the electronic device 1. The image of the flattened carton is taken by the camera 50.

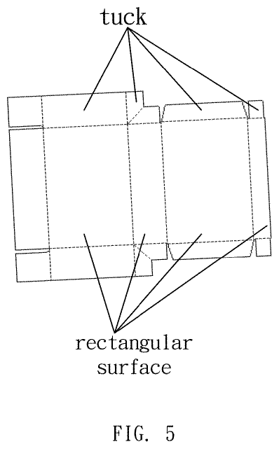

In step S103, the image of the carton is used to determine whether the carton is intact. Specifically, in step S103, the image of the carton is used to determine whether the carton complies with a standard sample. As shown in FIG. 5, the standard sample includes four rectangular surfaces connected to each other, each rectangular surface is provided with inserts on opposite sides. Tucks are provided on one side of any rectangular surface at both ends. Thus, the carton is determined to have compliance with standard sample when the image of the carton shows four rectangular surfaces connected to each other, each rectangular surface being provided with inserts on opposite sides, and tucks are on one side of any rectangular surface at both ends. If any of the above conditions are not met, it will be determined as not complying with standard sample.

In step S103, the image of the carton is analyzed as to whether a damage area in included when the carton complies with standard sample. In the embodiment, the image of the carton is compared with the standard sample to determine is there any damage area in the carton. It is determined that the carton is damaged if the image of the carton contains one or more damage areas and if so the process continues to step S104. It is determined that the carton is intact and reusable if the image of the carton contains no damage areas and if so the process continues to step S110.

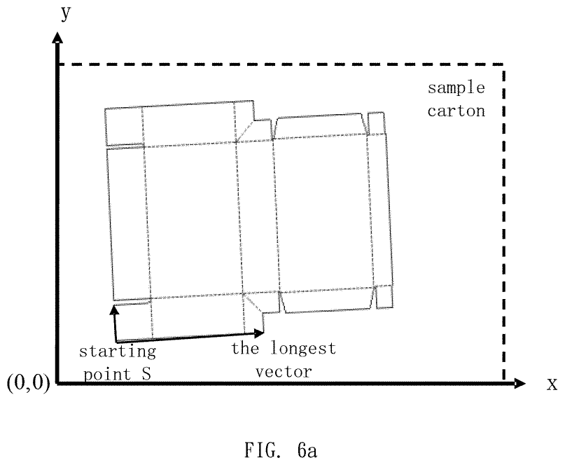

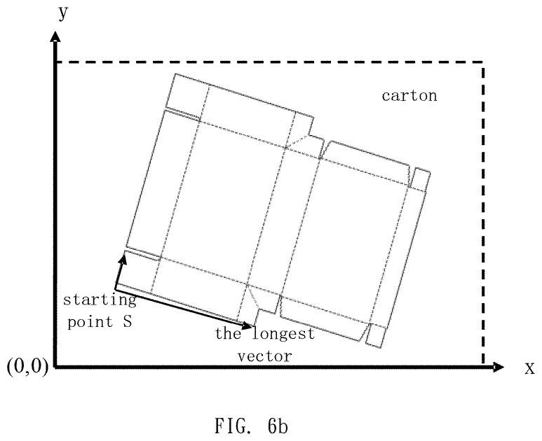

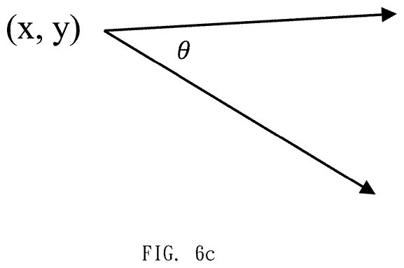

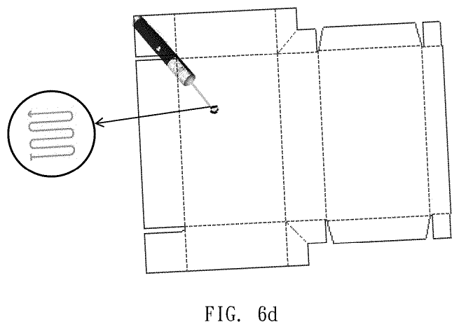

In step S104, a clamping device 60 is controlled to adjust a placement of the carton. Thus, the placement of the carton is same as a placement of a sample carton, that is, the carton under test is superimposed on the position of a sample carton. Specifically, as shown in FIG. 6a, the image of the sample carton is pre-obtained by the camera 50.

As shown in FIG. 6b, difference in side length between the image of the carton and the side length of the image of the sample carton is determined as being more or less than a threshold value. A first vector sequence is determined with each transition point in the image of the carton and a second vector sequence is determined with each transition point in the image of the sample carton when the difference between side length in the image of the carton and the side length of the image of the sample carton is not more than the threshold value. Determining whether length of the longest vector in the image of the carton is the same as length of the longest vector in the image of the sample carton when number of the first vector sequence is same as number of the second vector sequence.

As shown in FIG. 6c, a starting point of the longest vector in the image of the carton is taken as a starting point S of the vector sequence of the image of the carton in a coordinate system when the length of the longest vector in the image of the carton and length of another vector with the same starting point are respectively the same as the length of the longest vector in the image of the sample carton and length of another vector with the same starting point. A starting point of the longest vector in the image of the sample carton is taken as the starting point S of the vector sequence of the image of the sample carton in the coordinate system when the length of the longest vector in the image of the carton and length of another vector with the same starting point are respectively the same as the length of the longest vector in the image of the sample carton and length of another vector with the same starting point.

The starting point S (x, y) of the image of the sample carton is taken as a reference point to determine an angle θ between the longest vector in the image of the carton under test and the longest vector in the image of the sample carton. In step S104, the clamping device 60 is controlled to rotate the carton by the angle θ, so that a side corresponding to the longest vector of the carton coincides with a side corresponding to the longest vector of the sample carton. Thus, the placement of the carton is the same as the placement of the sample carton.

In step S105, at least one damaged area is scanned by the distance-measuring device 40 to obtain the shape of each damage area. Specifically, in step S105, the distance-measuring device 40 is controlled to scan the damaged area of the carton with the planned path to obtain the shape when the placement of the carton is the same as the placement of the sample carton. As shown in FIG. 6d, the planned path is a path that moves back and forth along a damaged area.

In step S106, the damage type is identified according to the shape of a damaged area. In the embodiment, the step S106 includes converting the shape of the damage area into the D-image. The D-image is classified to identify the damage type of each damaged area according to the damage-recognition model.

In step S107, damage rates are calculated according to the damage type in the area of damage. In the embodiment, the damage rates include tear-damage rate, damage rate of the tuck, hole-damage rate of the rectangular surface, crease-damage rate of the tuck, crease-damage rate of the rectangular surface, and wetness-damage rate.

The tear-damage rate=tear length/folding line length, the damage rate of the tuck=number of the damaged tuck/total number of the damaged tuck, the hole-damage rate of the rectangular surface=area of the hole of the rectangular surface/total area of the rectangular surface, the crease-damage rate of the tuck=length of the crease-damage on the tuck/total length of the tuck, the crease-damage rate of the rectangular surface=length of the crease-damage on the rectangular surface/total length of the rectangular surface, the wetness-damage rate=area of wetness/total area of the carton. In step S107, the damage rates of the carton are calculated according to a position of the area of damage, the damage type, and the damage rate. The position of the damaged area includes fold lines of the carton, the tuck, and the rectangular surface. The damage rate includes the tear length, the number of the damaged tucks, the number of the holes on rectangular surface, the crease-damaged length of the rectangular surface, and a wetness-area of the carton.

In step S108, the damage rate of the carton is at least equal to a standard value. In the embodiment, a total damage rate is sum of all types of the damage rates of the carton. The carton is determined to be repairable when the total damage rate is less than the standard value, and step S109 is applied. The carton is determined to be unrepairable when the total damage rate is greater than or equal to the standard value, and step S111 is applied.

In step S109, a repair device 70 repairs the damaged area according to a default-repair plan. In the embodiment, step S109 is applied when the tear-damage rate is determined to be less than a first threshold value, when the damage rate of the tuck is determined to be less than a second threshold value, when the hole-damage rate of the rectangular surface is determined to be less than a third threshold value, when the crease-damage rate of the tuck is determined to be less than a fourth threshold value, when the crease-damage rate of the rectangular surface is determined to be less than a fifth threshold value, and when the wetness-damage rate is determined to be less than a sixth threshold value.

In the embodiment, in step S109, the damaged area is repaired with the default-repair plan by the repair device 70 when any type of the damage rate is less than the standard value. The position of the damaged area and the type of the damage rate are determined to be unrepairable when any type of the damage rate is greater than or equal to the standard value. For example, the type of the hole-damage on the rectangular surface is determined to be unrepairable when the hole-damage rate of the rectangular surface is greater or equal to the third threshold value.

In the embodiment, each damage rate corresponds to the default-repair plan. For example, a first default-repair plan uses an adhesive tape to re-attach the damaged area for the type of the tear-damage. A second default-repair plan uses a hard plastic sheet to fix the damaged area for the tuck-damage type. A third default-repair plan uses the tape to cover the damaged area for the type of the hole-damage of the rectangular surface. A fourth default-repair plan uses the hard plastic sheet to fix the damaged area for the type of the crease-damage of the tuck. A fifth default-repair plan uses the hard plastic sheet to fix the damaged area for the type of the crease-damage of the rectangular surface. A sixth default-repair plan uses a drying method to dry the wet carton for the type of the wetness-damage carton.

In the step S110, the cartons are classified and recycled by controlling a recycling device 80. Dimensions and other information of the carton are taken and recorded by the recycling device 80. The cartons are classified and recycled according to the information of the carton. The recycling device 80 measures the size (length, width, high, etc.), volume, weight of the carton after the damaged areas are fixed according to the default-repair plan. The recycling device 80 records the information of the carton. The information of the carton includes the size, volume, weight, number of the damaged areas of the carton and the total damage rate. In the embodiment, the carton is classified according to any one of the information of the carton by the recycling device 80.

In the embodiment, in step S110, the information of the carton is stored into a memory of the electronic device 1. In step S111, the carton is discarded by the recycling device 80 when the total damage rate is greater or equal to the standard value. The carton is recycled by the recycling device 80 when the total damage rate is less than the standard value. Thus, the method for recycling carton uses computer imaging to determine the type of the damaged area and the damage rate, allowing automatic recycling of the reusable cartons. Therefore, the utilization rate of cartons is improved, the waste of resources is reduced, and the production cost is reduced.

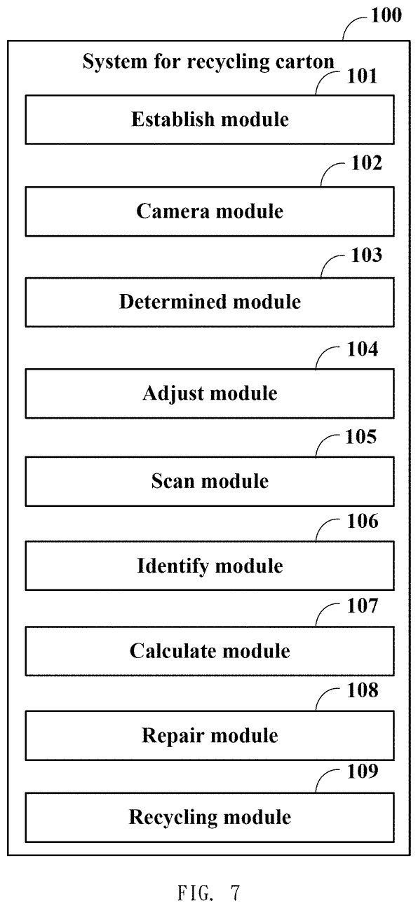

FIG. 7 shows an application structure of the carton recycling system in one embodiment. In the embodiment, the carton recycling system operates in the electronic device 1. The carton recycling system 100 includes multiple functional modules composed of programs. The programs of the carton recycling system 100 are stored in the memory of the electronic device 1 and be executed by at least one processor.

In the embodiment, functions in the carton recycling system can be divided into multiple function modules. As shown in FIG. 7, the function modules include an establish module 101, a camera module 102, a determined module 103, an adjust module 104, a scan module 105, an identify module 106, a calculate module 107, a repair module 108, and a recycling module 109. The modules of the embodiment mean that the programs with specific functions are stored in the memory and are executed by at least one processor.

The establish module 101 is used to establish the damage-recognition model based on the shape of damage corresponding to the damaged area of the known damage type on the damaged sample. The camera module 102 is used to obtain the images of the cartons. The determined module 103 is used to determine whether the carton is damaged by comparing the image of the carton with the standard sample to determine if there is any damaged area in the carton. The determined module 103 is further used to determine whether the total damage rate is greater or equal to the standard value. The adjust module 104 is used to adjust the placement of the carton by the clamping device 60. The placement of the carton is adjusted to have the same placement as the sample carton. The scan module 105 is used to obtain the shape of damage by scanning the damaged area of the carton. The identify module 106 is used to identify the type of the damaged area according to the shape of damage. The calculate module 107 is used to calculate the damage rate according to the type of the damaged area. The repair module 108 is used to control the repair device 70 to repair the damaged area with the default-repair plan. The recycling module 109 is used to recycle the carton when the total damage rate is less than the standard value.

The processor 10 can be a central processing unit (CPU), or can be other general-purpose processors, digital signal processor (DSP), and dedicated integrated circuits (Application Specific Integrated Circuit, ASIC), Field-Programmable Gate Array (FPGA), or other programmable logic device, discrete gate or transistor logic devices, discrete hardware components, etc. The general-purpose processor can be a microprocessor or the processor can also be any conventional processor, etc. The processor is the control center, using various interfaces to connect the various parts of the operable device.

The memory 20 can be used to store computer programs and/or modules. The processor can implement the method by executing the programs, and/or modules stored in the memory. Various functions of the device can be operated. The memory includes a storage program area and a storage data area. The storage program area can store the operating system, at least one application program (such as sound playback function, image playback function, etc.), etc. The storage data area can store any data created. The memory can include random access memory and also include non-volatile memory, such as hard disks, memory, plug-in hard disks, smart memory card (smart media card, SMC), secure digital (secure digital, SD) card, flash memory card (flash card), at least one magnetic disk memory device, flash memory device, or other volatile solid-state memory device.

The distance-measuring device 40 can be the laser rangefinder or an infrared distance meter in the embodiment. The clamping device 60 is a robot arm. The repair device 70 at least includes an attaching mechanism and a heating mechanism. The tape is attached on the damaged area and the hard plastic sheet be fixed on the damaged area by the attaching mechanism. Heat can be applied to the wetness-area of the carton by the heating mechanism. The recycling device 80 includes a measuring mechanism and a packaging mechanism. The size of the carton is measured by the measuring mechanism and the carton for reuse can be packaged by the packaging mechanism.

Each one of the modules of the electronic device 1 is realized in form of a software functional unit and used as an independent product. One or more programs are stored in the storage medium. The one or more programs can be executed by one or more processor to implement the embodiment of the carton recycling method. The storage medium of the embodiment includes volatile, non-volatile, and removable storage implemented in any method or technology for storing information (such as computer readable instructions, data structures, program modules or other data). The storage media includes but is not limited to RAM, ROM, EEPROM, flash memory, or other memory technologies, CD-ROM, digital versatile disk (DVD) or other optical disk storage, magnetic cassettes, magnetic tapes, magnetic disk storage or other magnetic storage device or any other medium that can be used to store information that can be accessed by a computer.

The method for recycling carton uses computer imaging to determine the type of the damaged area and the damage rate. Automatic recycling of the reusable cartons can be performed. Therefore, the utilization rate of cartons is improved, the waste of resources is reduced, and the production cost is reduced.

The embodiments shown and described above are only examples. Therefore, many details of such art are neither shown nor described. Even though numerous characteristics and advantages of the technology have been set forth in the foregoing description, together with details of the structure and function of the disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for recycling carton, comprising:
obtaining an image of a carton by a camera;
recognizing the image of the carton to determine whether the carton is damaged;
obtaining a trajectory of a damaged area of the carton by scanning with a distance-measuring device when the carton is determined as damaged;
determining a damage type of the damaged area according to the trajectory of the damaged area;
calculating a damage rate of the carton according to the damage type of the damaged area;
determining whether a sum of the damage rate is less than a standard value;
repairing the damaged area according to a default-repair plan when the sum is less than the standard value; and
classifying and recycling the repaired carton.

2. The method of claim 1, wherein the step of determining whether the carton is damaged further comprises:
determining whether the image of the carton compliances with a standard sample;
determining the carton is damaged when the image of the carton contains at least one damaged area;
determining the carton is not damaged when the image of the carton does not contain any damaged area.

3. The method of claim 1, further comprises:
controlling a clamping device to adjust a placement position of the carton, wherein the placement position of the carton is same as a placement position of a sample carton.

4. The method of claim 1, further comprises:
scanning the damaged area in a planned path to obtain a damage trajectory by a distance-measuring device.

5. The method of claim 4, further comprises:
converting the damage trajectory into a damaged-trajectory image;
obtaining features of the damage-trajectory image and classifying the damage type according to a CNN (Convolution Neural Network) model to build a damage-recognition model.

6. The method of claim 5, further comprises:
classifying the damaged type of the damaged-trajectory image according to the damage-recognition model, wherein the damaged type includes a normal type, a tear type, a hole type, a crease type, and a wet type.

7. The method of claim 6, further comprises:
calculating the damage rate according to the damaged type of the damage area, wherein the damage rate include tear-damage rate, damage rate of the tuck, hole-damage rate of the rectangular surface, crease-damage rate of the tuck, crease-damage rate of the rectangular surface, and wet-damage rate.

8. The method of claim 7, wherein the step of repairing the damaged area further comprises:
determining whether the damage rate is less than the standard value;
repairing the damaged area according to a default-repair plan when the damage rate is less than the standard value.

9. A system for recycling carton, comprising:
a camera obtains an image of a carton;
a memory;
a processor;
a program which is executed by the processor and is stored on the memory;
recognizing the image of the carton to determine whether the carton is damaged;
obtaining a trajectory of a damaged area of the carton by scanning with a distance-measuring device when the carton is determined as damaged;
determining a damage type of the damaged area according to the trajectory of the damaged area;
calculating a damage rate of the carton according to the damage type of the damaged area;
determining whether a sum of the damage rate is less than a standard value;
repairing the damaged area according to a default-repair plan when the sum is less than the standard value; and
classifying and recycling the repaired carton.

10. The system of claim 9, wherein the step of determining whether the carton is damaged further comprises:
determining whether the image of the carton compliances with a standard sample;
determining the carton is damaged when the image of the carton contains at least one damaged area;
determining the carton is not damaged when the image of the carton does not contain any damaged area.

11. The system of claim 9, further comprises:
controlling a clamping device to adjust a placement position of the carton, wherein the placement position of the carton is same as a placement position of a sample carton.

12. The system of claim 9, further comprises:
scanning the damaged area in a planned path to obtain a damage trajectory by a distance-measuring device.

13. The system of claim 12, further comprises:
converting the damage trajectory into a damaged-trajectory image;
obtaining features of the damage-trajectory image and classifying the damage type according to a CNN (Convolution Neural Network) model to build a damage-recognition model.

14. The system of claim 13, further comprises:
classifying the damaged type of the damaged-trajectory image according to the damage-recognition model, wherein the damaged type includes a normal type, a tear type, a hole type, a crease type, and a wet type.

15. The system of claim 14 further comprises:
calculating the damage rate according to the damaged type of the damage area, wherein the damage rate include tear-damage rate, damage rate of the tuck, hole-damage rate of the rectangular surface, crease-damage rate of the tuck, crease-damage rate of the rectangular surface, and wet-damage rate.

16. The system of claim 15, wherein the step of repairing the damaged area further comprises:
determining whether the damage rate is less than the standard value;
repairing the damaged area according to a default-repair plan when the damage rate is less than the standard value.
